(19) United States
(12) Patent Application Publication
(10) Pub. No.: US 2022/0268962 A1
(43) Pub. Date: Aug. 25, 2022

(54) A FLOOR DETERMINATION METHOD FOR TERMINAL DEVICES

(71) Applicant: Beijing Digital Union Web Science and Technology Company Limited, Beijing (CN)

(72) Inventors: Congan Yang, Beijing (CN); Haiting Wang, Beijing (CN); Jingjing Liu, Beijing (CN)

(21) Appl. No.: 16/623,494

(22) PCT Filed: Nov. 15, 2019
(86) PCT No.: PCT/CN2019/118628

§ 371 Date: Dec. 17, 2019

(30) Foreign Application Priority Data
Nov. 13, 2019 (CN) 201911106119.6

(51) Int. Cl. G01W 1/02; G06F 16/29

(52) U.S. Cl. CPC G01W 1/02; G06F 16/29

(57) ABSTRACT

The invention provides a floor determination method for terminal devices, including the steps: S1: generate the atmospheric pressure data of the datum floor; S2: divide the coordinate system of a map and establish city-level grid atmospheric pressure database; S3: add commercial label to the grid data; S4: add the datum atmospheric pressure and floor-height atmospheric pressure difference to each grid; S5: judge the floor according to the device atmospheric pressure. The advantages of this invention include: it puts forward the determination method of building floor originally and can accurately calculate the floor where the device is according to the testing data of atmospheric pressure and device sensor, and the whole process of the method is fast, intelligent and accurate.

### TECHNICAL FIELD

This invention belongs to the field of mobile terminal, in particular to a floor determination method of terminal devices based on the data of mass mobile Internet sensor.

### BACKGROUND TECHNOLOGY

In the field of altitude positioning, the current means of detecting the altitude of urban road surface are mainly carried out through on-board road test:

That is, detecting the altitudes of urban different areas through hand-held or on-board devices. The disadvantage of this mode is that it can only detect the altitudes of highways, blacktops, trunks, overpasses and other roads and only represent the altitudes of the roads in an area rather than feed back the typical real altitudes, making much different from the actual altitudes.

### CONTENTS OF INVENTION

The purpose of this invention is realized through the technical scheme as follows.

With the purpose to solve these problems, this invention will analyze, process and treat the names and coordinates (known) of mass WIFI data by collecting the mass WIFI names and altimeter information delivered, and extract the atmospheric pressure information delivered by the mid-end & high-end devices in the short buildings such as 1F, 2F and 3F of street shops. Then through processing, filtering and layering by the algorithm, it can establish the 3D height database based on level coordinates to provide data to the final device floor determination.

With the purpose to achieve the above purpose, the first execution case of this invention puts forward floor determination method of terminal devices, including the steps as follows:

S1: Generate the atmospheric pressure data of the datum floor;

S2: Divide the coordinate system of a map and establish city-level grid atmospheric pressure database;

S3: Add commercial label to the grid data;

S4: Add the datum atmospheric pressure and floor-height atmospheric pressure difference to each grid;

S5: Judge the floor according to the device atmospheric pressure.

Furthermore, the S1 includes:

S11: Select values: select three keywords that can exclusively identify the base station from the data of datum floor delivered from the terminal devices to determine an area;

S12: Eliminate the invalid data: calculate the mid-value and take the difference between the post-elimination data value and the mid-value;

S13: Calculate the filter threshold;

S14: Determine the level atmospheric pressure value of the area where the terminal device is.

Furthermore, the keywords include: operator, quarter ID, base station ID, atmospheric pressure, timestamp.

Furthermore, the filtering threshold is 3%.

Furthermore, the S2 includes:

S21: Determine the lower left and upper right range boundaries of a city on the selection map;

S22: Take the grid at the lower left corner as the initial point, and use Python open source coordinate transformation base to turn the initial point 45 degrees anticlockwise to form the upper right coordinate of the grid;

S23: Take the ending longitude as the next starting longitude, and keep the latitude unchanged;

S24: Add the ID to the grid whenever a grid is generated;

S25: Use the boundary database of a city and the ray algorithm to eliminate the grids outside the area of the city and generate the final grid base.

Furthermore, the S3 includes:

S31: Add the commercial attribute mark to each grid combined with the data of POIs;

S32: Match the commercial attribute of the POI corresponding to each grid using the GEO-HASH technology;

S33: After matching, add mark to each grid data.

Furthermore, the S4 includes:

S41: Screen MapReduce using coordinates, and transform all base station data and related pressure data inside each grid to the datum atmospheric pressure and altitude therein by the datum atmospheric pressure generation method;

S42: Determine the floor height according to the grid data with commercial marks;

S43: Calculate the altitude and atmospheric pressure of each floor by taking the datum atmospheric pressure and altitude as the starting point and take them into the base. Each grid corresponds to the atmospheric pressure values of a plurality of floors.

Furthermore, the S5 includes:

S51: Determine the longitude and latitude according to the base station ID delivered by the current device;

S52: Determine the grid through the longitude and latitude according to the GEO-HASH algorithm;

S53: Obtain the standard atmospheric pressures of a plurality of floors inside a grid according to the grid ID;

S54: Search the range of the floor atmospheric pressure of the grid according to the atmospheric pressure of the current device, and add the mark to the current floor according to the search results.

With the purpose to achieve the above purpose, the second execution case of this invention puts forward an electronic device, comprising: memory, processor and computer program which is stored in the memory and can run in the processor, and it will be executed to realize any method above when the processor operates the computer program

With the purpose to achieve the above purpose, the third execution case of this invention puts forward a computer-readable storage medium with computer program, and it will be executed to realize any method above when the processor operates the computer program.

The advantages of this invention include: it puts forward the determination method of building floor originally and can accurately calculate the floor where the device is according to the testing data of atmospheric pressure and device sensor, and the whole process of the method is fast, intelligent and accurate.

### ILLUSTRATIONS

By reading the details of the selected execution modes below, the common technicians of this field will be clear of all advantages and benefits. The figures are only used to show the purposes of the selected execution modes rather than restrict this invention. In addition, in the whole figures, the same reference symbols shall be used to represent the same parts. In the figures:

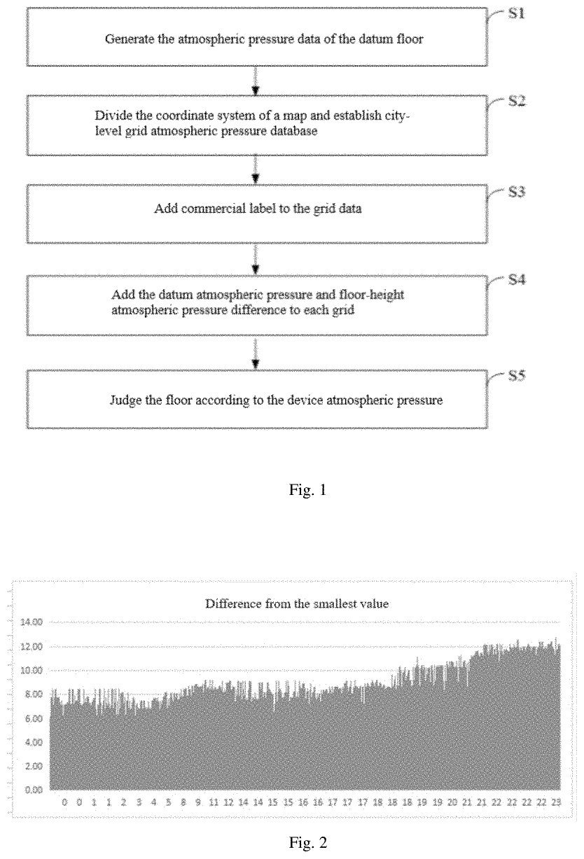

FIG. 1 shows the flowchart of a floor determination method for terminal devices according to the execution modes of this invention;

FIG. 2 shows the schematic diagram of fluctuation of the measured data of the atmospheric pressure according to the execution modes of this invention;

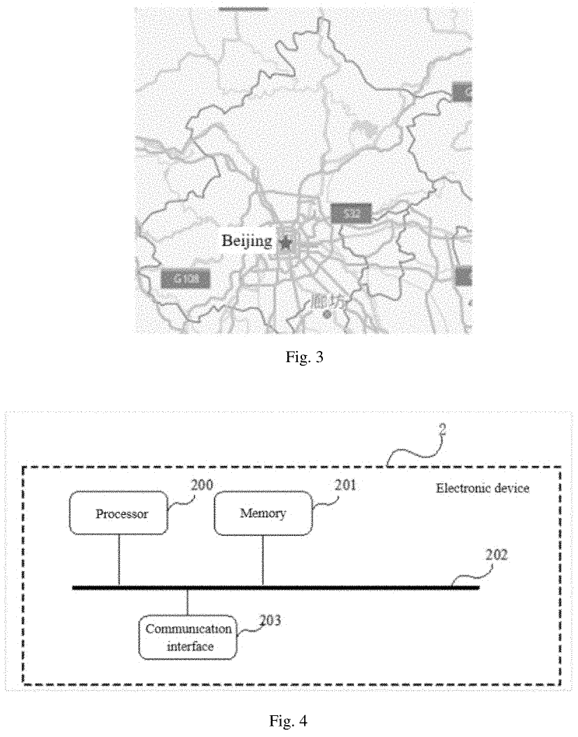

FIG. 3 shows the map of Beijing according to an embodiment of the invention;

FIG. 4 shows the structural diagram of an electronic device provided by an execution case of this invention;

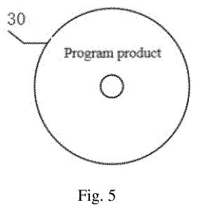

FIG. 5 shows the schematic diagram of a computer medium provided by an execution case of this invention.

### SPECIFIC EXECUTION MODES

We will describe the typical execution modes in detail with the reference to the figures. Though the figures show the typical execution modes of this invention, we shall understand that this invention can be realized in all forms rather than be restricted by the execution mode herein. On the contrary, these execution modes are provided with the purpose to make this invention more understandable and transmit the scope of this invention to the technicians of this field.

Noted that unless otherwise specified, the technical terms or scientific terms used in this invention shall be the general meaning understood by the technicians of this field. In addition, the terms “first”, “second” and the like are used to distinguish different objects rather than to describe a particular order. In addition, the terms “include”, “have” and their deformations are intended to cover the non-exclusive inclusions. For example, the processes, methods, systems, products or devices that contain a series of steps or units are not limited to the listed steps or units, but optionally also include the steps or units that are not listed, or optionally include other steps or units that are fixed to these processes, methods, products or devices.

This invention provides a floor determination method for terminal devices. The purpose of floor determination: in the field of floor determination, with the purpose to obtain the most accurate image data, all parameters of many sensor measurement devices such as GPS, WIFI and base station are usually used to describe the position of the devices. In general, the commercial behaviors of devices can be estimated and calculated in 2D. But the real scenarios such as high rises and multi-storey malls always exist in 3D instead of 2D. With the purpose to describe the commercial attributes of devices, it is necessary to determine the floor by algorithm, such as determining shops combined with the floor data of POIs.

In this invention, the urban road surface refers to the road surfaces/lands which can represent the average altitude of an area and the grounds which can objectively reflect the altitude of the area. The sensor data refers to the general designation of various sensors by mobile terminals. The key point of this invention is to study the height barometers and converse to the altitude via certain conversion relation.

This invention determines the datum 2D atmospheric pressure of this area through big data calculation and noise filtering; introduces the concept of grids; realizes the match of the longitude & latitude with grid ID using the GEO-HASH technology; washes grids by ray algorithm; generates the standard floor atmospheric pressure value of the area as per the formula as the basis of determining the floor.

In detail, as shown in FIG. 1, the floor determination method for terminal devices based on the data of mass mobile Internet sensors includes the steps as follows:

S1: Generate the atmospheric pressure of the datum floor (1F/ground). The realization process of S1 includes:

S11: Select values: select three keywords that can exclusively identify the base station from the data of datum floor delivered from the terminal devices to determine an area;
Operator: MNC_ID
Quarter ID: LAC_ID
Base station ID: CELL_ID
Atmospheric pressure
Timestamp

S12: Eliminate the invalid data: calculate the mid-value and take the difference between the post-elimination data value and the mid-value:

minus=A−median/median

S13: Calculate the filter threshold.

The calculation relation between altitude and atmospheric pressure:

double height=44330000*(1−(Math.pow((Double.parseDouble(df.format(sPV))/1013.25), (float)1.0/5255.0)));

When the atmospheric pressure over 20% difference occurs between the data of an area (200 m), it shows the data have had the following difference in altitude:

Atmospheric pressure (hpa) altitude (m)

| | |
|---|---|
| 887.932 | 1113.7222536193747 |
| 717.33575 | 2913.3540216302144 |
| 594.83307 | 4493.025788287187 |
| 701.0047 | 3107.7182898607794 |
| 717.33575 | 2913.3540216302144 |

Therefore, the 1,000 m difference in altitude cannot exist within the range of 200 m. So we can eliminate the data of over 20% and reserve the data of the error within 3%. S14. Determine the smallest value i.e. the 2D atmospheric pressure value of the area. Determine the lowest atmospheric pressure of a day through statistics. If the quantity is insufficient, we can make statistics of the atmospheric pressure data of the area within one week.

For example, in the following table, the first rank on the left is the measured values of atmospheric pressure of different surveillance points, the second rank is the measurement time, the third rank is the difference between each data and the mid-value of the whole data and the fourth rank is the error rate between each data and the mid-value. We can eliminate the data with the error over 20% from the mid-value through screening, reserve the data with the error within 30%, delete the exceptional data points and make results more closer to the reality.

| | | Difference | |
|---|---|---|---|
| | | from the | |
| | | mid-value | |
| Atmospheric | | Mid-value: | |
| pressure HPA | Time stamp | 887.93201 | Percentage |
| 589.196167 | 2019 Jun. 30 09:37:08 | −298.74 | −33.64% |
| 590.035706 | 2019 Jun. 30 16:14:55 | −297.90 | −33.55% |
| 591.884705 | 2019 Jun. 30 20:06:35 | −296.05 | −33.34% |
| 594.833069 | 2019 Jun. 30 08:33:16 | −293.10 | −33.01% |
| 595.912476 | 2019 Jun. 30 16:12:51 | −292.02 | −32.89% |
| 639.918274 | 2019 Jun. 30 23:33:24 | −248.01 | −27.93% |
| 643.186523 | 2019 Jun. 30 21:10:12 | −244.75 | −27.56% |
| 701.0047 | 2019 Jun. 30 11:18:21 | −186.93 | −21.05% |
| 717.335754 | 2019 Jun. 30 07:13:33 | −170.60 | −19.21% |
| 717.335754 | 2019 Jun. 30 12:15:12 | −170.60 | −19.21% |
| 717.335754 | 2019 Jun. 30 14:35:14 | −170.60 | −19.21% |
| 880.486084 | 2019 Jun. 30 14:26:09 | −7.45 | −0.84% |
| 881.455566 | 2019 Jun. 30 13:40:42 | −6.48 | −0.73% |
| 881.455566 | 2019 Jun. 30 14:01:13 | −6.48 | −0.73% |
| 883.464417 | 2019 Jun. 30 02:15:16 | −4.47 | −0.50% |
| 883.464417 | 2019 Jun. 30 02:46:52 | −4.47 | −0.50% |
| 883.464417 | 2019 Jun. 30 06:29:40 | −4.47 | −0.50% |
| 884.633789 | 2019 Jun. 30 22:36:03 | −3.30 | −0.37% |
| 884.893677 | 2019 Jun. 30 10:15:08 | −3.04 | −0.34% |
| 884.893677 | 2019 Jun. 30 11:19:35 | −3.04 | −0.34% |
| 884.893677 | 2019 Jun. 30 13:09:24 | −3.04 | −0.34% |
| 884.893677 | 2019 Jun. 30 13:28:24 | −3.04 | −0.34% |
| 885.243469 | 2019 Jun. 30 09:46:05 | −2.69 | −0.30% |
| 885.573242 | 2019 Jun. 30 01:53:36 | −2.36 | −0.27% |
| 885.573242 | 2019 Jun. 30 02:38:01 | −2.36 | −0.27% |
| 885.573242 | 2019 Jun. 30 03:39:49 | −2.36 | −0.27% |
| 885.573242 | 2019 Jun. 30 05:13:12 | −2.36 | −0.27% |
| 885.573242 | 2019 Jun. 30 06:52:53 | −2.36 | −0.27% |
| 885.83313 | 2019 Jun. 30 10:22:13 | −2.10 | −0.24% |
| 885.83313 | 2019 Jun. 30 10:36:29 | −2.10 | −0.24% |
| 886.362854 | 2019 Jun. 30 21:18:00 | −1.57 | −0.18% |
| 886.802612 | 2019 Jun. 30 10:25:30 | −1.13 | −0.13% |
| 887.222351 | 2019 Jun. 30 15:18:31 | −0.71 | −0.08% |
| 887.222351 | 2019 Jun. 30 15:32:32 | −0.71 | −0.08% |
| 887.392273 | 2019 Jun. 30 21:43:29 | −0.54 | −0.06% |
| 887.492188 | 2019 Jun. 30 19:00:34 | −0.44 | −0.05% |
| 887.492188 | 2019 Jun. 30 20:05:46 | −0.44 | −0.05% |
| 887.492188 | 2019 Jun. 30 20:39:41 | −0.44 | −0.05% |
| 887.492188 | 2019 Jun. 30 21:30:42 | −0.44 | −0.05% |
| 887.542175 | 2019 Jun. 30 16:04:21 | −0.39 | −0.04% |
| 887.552185 | 2019 Jun. 30 12:09:24 | −0.38 | −0.04% |
| 887.582153 | 2019 Jun. 30 16:07:15 | −0.35 | −0.04% |
| 887.702087 | 2019 Jun. 30 21:37:10 | −0.23 | −0.03% |
| 887.712097 | 2019 Jun. 30 16:30:28 | −0.22 | −0.02% |
| 887.712097 | 2019 Jun. 30 17:07:14 | −0.22 | −0.02% |
| 887.722107 | 2019 Jun. 30 16:08:08 | −0.21 | −0.02% |
| 887.732056 | 2019 Jun. 30 07:19:17 | −0.20 | −0.02% |
| 887.732056 | 2019 Jun. 30 21:19:33 | −0.20 | −0.02% |
| 887.921997 | 2019 Jun. 30 15:49:32 | −0.01 | 0.00% |
| 887.932007 | 2019 Jun. 30 15:24:19 | 0.00 | 0.00% |
| 887.932007 | 2019 Jun. 30 16:03:02 | 0.00 | 0.00% |
| 887.981934 | 2019 Jun. 30 15:35:51 | 0.05 | 0.01% |
| 888.021912 | 2019 Jun. 30 16:08:24 | 0.09 | 0.01% |
| 888.031921 | 2019 Jun. 30 15:40:26 | 0.10 | 0.01% |
| 888.321777 | 2019 Jun. 30 16:11:28 | 0.39 | 0.04% |
| 888.321777 | 2019 Jun. 30 16:21:30 | 0.39 | 0.04% |
| 888.321777 | 2019 Jun. 30 19:57:35 | 0.39 | 0.04% |
| 888.321777 | 2019 Jun. 30 21:16:37 | 0.39 | 0.04% |
| 888.361755 | 2019 Jun. 30 15:24:37 | 0.43 | 0.05% |
| 888.361755 | 2019 Jun. 30 15:35:52 | 0.43 | 0.05% |
| 888.361755 | 2019 Jun. 30 15:41:50 | 0.43 | 0.05% |
| 888.361755 | 2019 Jun. 30 15:56:17 | 0.43 | 0.05% |
| 888.491699 | 2019 Jun. 30 09:15:54 | 0.56 | 0.06% |
| 888.601624 | 2019 Jun. 30 15:35:34 | 0.67 | 0.08% |
| 888.67157 | 2019 Jun. 30 14:27:05 | 0.74 | 0.08% |
| 888.67157 | 2019 Jun. 30 14:50:31 | 0.74 | 0.08% |
| 888.67157 | 2019 Jun. 30 14:55:24 | 0.74 | 0.08% |
| 888.67157 | 2019 Jun. 30 14:59:48 | 0.74 | 0.08% |
| 888.67157 | 2019 Jun. 30 16:34:50 | 0.74 | 0.08% |
| 888.751526 | 2019 Jun. 30 14:10:07 | 0.82 | 0.09% |
| 888.961426 | 2019 Jun. 30 14:15:57 | 1.03 | 0.12% |
| 888.961426 | 2019 Jun. 30 14:28:37 | 1.03 | 0.12% |
| 889.031372 | 2019 Jun. 30 17:24:19 | 1.10 | 0.12% |
| 889.031372 | 2019 Jun. 30 23:13:59 | 1.10 | 0.12% |
| 889.031372 | 2019 Jun. 30 23:35:08 | 1.10 | 0.12% |
| 889.07135 | 2019 Jun. 30 11:04:27 | 1.14 | 0.13% |
| 889.08136 | 2019 Jun. 30 21:20:57 | 1.15 | 0.13% |
| 889.08136 | 2019 Jun. 30 23:16:08 | 1.15 | 0.13% |
| 889.161316 | 2019 Jun. 30 16:03:37 | 1.23 | 0.14% |
| 889.161316 | 2019 Jun. 30 21:08:44 | 1.23 | 0.14% |
| 889.171265 | 2019 Jun. 30 07:57:44 | 1.24 | 0.14% |
| 889.181274 | 2019 Jun. 30 07:08:49 | 1.25 | 0.14% |
| 889.221252 | 2019 Jun. 30 17:43:23 | 1.29 | 0.15% |
| 889.371216 | 2019 Jun. 30 15:59:50 | 1.44 | 0.16% |
| 889.381165 | 2019 Jun. 30 19:36:11 | 1.45 | 0.16% |
| 889.451172 | 2019 Jun. 30 06:05:34 | 1.52 | 0.17% |
| 889.451172 | 2019 Jun. 30 21:46:20 | 1.52 | 0.17% |
| 890.510559 | 2019 Jun. 30 15:34:43 | 2.58 | 0.29% |
| 890.600525 | 2019 Jun. 30 20:19:42 | 2.67 | 0.30% |
| 890.870361 | 2019 Jun. 30 21:35:08 | 2.94 | 0.33% |
| 890.950317 | 2019 Jun. 30 21:01:26 | 3.02 | 0.34% |
| 890.960327 | 2019 Jun. 30 00:00:25 | 3.03 | 0.34% |
| 890.960327 | 2019 Jun. 30 06:10:49 | 3.03 | 0.34% |
| 890.960327 | 2019 Jun. 30 07:18:49 | 3.03 | 0.34% |
| 890.960327 | 2019 Jun. 30 16:02:55 | 3.03 | 0.34% |
| 891.360107 | 2019 Jun. 30 22:36:14 | 3.43 | 0.39% |
| 893.73877 | 2019 Jun. 30 10:58:01 | 5.81 | 0.65% |
| 895.317932 | 2019 Jun. 30 10:31:07 | 7.39 | 0.83% |
| 895.317932 | 2019 Jun. 30 11:06:22 | 7.39 | 0.83% |
| 895.317932 | 2019 Jun. 30 21:45:24 | 7.39 | 0.83% |

As shown in FIG. 2, the x-coordinate represents the present time of the present atmospheric pressure (hours) and the y-coordinate represents the difference between the present value and the smallest value of the atmospheric pressure (after invalid data are eliminated). By calculating the difference between the present value and the smallest value of the atmospheric pressure (after invalid data are eliminated), we can see the fluctuation of the present value.

S2: Divide the coordinate system of a map and establish city-level grid air pressure database. The realization process of the S2 includes:

S21: Determine the lower left and upper right range boundaries of a city on the selection map;
Lower left coordinate: lng_left,lat_bottom
Upper right coordinate: lng_right,lat_up

As shown in FIG. 3, for example, the longitude and latitude of Beijing can use the range of the coordinate: 115.397304E, 39.427753N; 117.660172E, 41.333973N.

S22: Take the grid at the lower left corner as the initial point, and use Python open source coordinate transformation base to turn the initial point 45 degrees anticlockwise to form the upper right coordinate of the grid, i.e. start_lng, start_lat,end_lng,end_lat
Starting=115.397304
Start lat=39.427753
Id=1

S23: Take the ending longitude (end_lng) as the next starting longitude, and keep the latitude unchanged;
Start_lng=end_lng
Start_lat=start_lat
Id=2

S24: Add the ID to the grid whenever a grid is generated, forming the datasheet as follows:

| grid_id | city_name | start_lng | start_lat | end_lng | end_lat |
|---|---|---|---|---|---|
| 1 | beijing | 116.091227 | 39.706757 | 116.094802 | 39.709518 |
| 2 | beijing | 116.094802 | 39.706757 | 116.098377 | 39.709518 |
| 3 | beijing | 116.098377 | 39.706757 | 116.101951 | 39.709518 |
| 4 | beijing | 116.101951 | 39.706757 | 116.105526 | 39.709518 |
| 5 | beijing | 116.105526 | 39.706757 | 116.109101 | 39.709518 |
| 6 | beijing | 116.109101 | 39.706757 | 116.112676 | 39.709518 |
| 7 | beijing | 116.112676 | 39.706757 | 116.116251 | 39.709518 |
| 8 | beijing | 116.116251 | 39.706757 | 116.119825 | 39.709518 |
| 9 | beijing | 116.119825 | 39.706757 | 116.1234 | 39.709518 |
| 10 | beijing | 116.1234 | 39.706757 | 116.126975 | 39.709518 |

S25: Use the boundary database of Beijing (from the Baidu Map) and the ray algorithm to eliminate the grids outside Beijing and generate the final grid base. The ray algorithm is to judge whether the data grids are inside the polygon; if yes, fill it; if no, don't fill it.

S3: Add commercial marks (office or residence) to grid data. The realization process of the S3 includes:

S31: Add the commercial attribute mark to each grid (office or residence) combined with the data of POIs;

S32: Match the commercial attribute of the POI corresponding to each grid using the GEO-HASH technology;

S33: After matching, add mark to each grid data.

S4: Add the difference between the datum atmospheric pressure and floor height atmospheric pressure to each grid. The realization process of the S4 includes:

S41: Screen MapReduce (a common data processing mode for big data) using coordinates, and transform all base station data and related pressure data inside each grid to the datum atmospheric pressure and altitude therein by the datum atmospheric pressure generation method;

S42: Determine the floor height according to the grid data with commercial marks. The office building is set as 3.5 m and the residence building is set as 3 m;

S43: Calculate the altitude and atmospheric pressure of each floor by taking the datum atmospheric pressure and altitude as the starting point and take them into the base. Each grid corresponds to the atmospheric pressure values of a plurality of floors.

Datum atmospheric pressure (1F atmospheric pressure): p1=880.486084

2F atmospheric pressure:: p2=880.12475

3F atmospheric pressure:: p3=879.75965

4F atmospheric pressure:: p4=879.39470

5F atmospheric pressure:: p5=879.02991

Calculation formula:

sPV=1013.25*Math.pow(1−(height/44330000),5255)

S5: Judge the floor according to the atmospheric pressure of the device. The realization process of the S5 includes:

S51: Determine the longitude and latitude according to the base station ID delivered by the current device;

S52: Determine the grid through the longitude and latitude according to the GEO-HASH algorithm;

S53: Obtain the standard atmospheric pressures of a plurality of floors inside a grid according to the grid ID;

S54: Search the range of the floor atmospheric pressure of the grid according to the atmospheric pressure of the current device, and add the mark to the current floor according to the search results.

For example: if the atmospheric pressure of the current device is 879.39580, the value will be within 3F (879.75965) and 4F (879.39470) and the mark 3F will be added.

The execution modes of this invention also provides an electronic device corresponding to the floor determination method for terminal devices provided in the aforementioned execution modes to execute the floor determination method for terminal devices. The electronic device can be mobile phone, tablet computer and camera, which is not restricted in the execution cases of this invention.

With the reference to FIG. 4 which is the schematic diagram of the electronic devices provided by certain execution modes of this invention, the electronic device 2 comprises the processor 200, the memory 201, the bus 202 and the communication interface 203, and the processor 200, communication 203 and the memory 201 are connected through the bus 202; the memory 201 stores the computer program which can run in the processor 200 and the processor 200 will execute the floor determination method for terminal devices provided by any execution mode of this invention when it operates the computer program.

Thereof, the memory 201 may contain high-speed random access memory (RAM) and/or non-volatile memory which may be minimum one disk memory. The system network element may be communicated with minimum the other network element through minimum one communication interface 203 (wire or wireless), making the Internet, WAN, local network and MAN available.

The processor 200 may be a kind of integrated circuit chip with signal processing capability. During the execution, each step of the above method can be completed through the integrated logic circuit of the hardware or the instruction in the form of software in the processor 200. The above processor 200 can be general-purpose processor, comprising central processing unit (CPU), network processor (NP), etc.; or a digital signal processor (DSP), ASIC, FPGA or other programmable logic device, discrete gate or transistor logic device, and discrete hardware component, which can realize or execute all methods, steps and logic block diagrams in the execution cases of this invention. The general-purpose processor may be a microprocessor or any conventional processor, which can directly present the completion by the hardware decode processor or by the module of hardware and software in the decode processor combined with the steps of the methods disclosed in the execution cases of this invention. The software module can lie in RAM, FM, ROM, ROMP, EEPROM, MTRR and other mature storage mediums of this field which lie in the memory 201. The processor 200 will read the information of the memory 201 and complete the steps of the above methods combined with its hardware.

The electronic devices provided by the execution cases of this invention and the floor determination method for terminal devices provided by execution cases of this invention are of the same inventive concept, and have the same beneficial effect as the method adopted, operated or realized.

The execution modes of this invention also provide a kind of computer-readable mediums corresponding to the floor determination method for terminal devices provided by the aforesaid execution modes. With reference to the FIG. 5, the computer-readable storage medium is CD30 with the computer program (i.e. program product) and will execute the floor determination method for terminal devices provided by any aforesaid execution modes when the computer program is executed by the processor. Noted that the examples of the computer-readable storage mediums can also include with limitation to, PRAM, SRAM, DRAM, RAM, ROM, EEPROM, FM or other optical and magnetic storage mediums, which is not described herein.

The computer-readable mediums provided by the execution cases of this invention and the floor determination method for terminal devices provided by execution cases of this invention are of the same inventive concept, and have the same beneficial effect as the method adopted, operated or realized by the App stored

In the description of the specification, the reference terms “an execution case”, “certain execution cases”, “examples”, “specific examples”, or “certain examples” means the minimum one execution case or example contained in this invention combined with the specific features, structures, materials or characteristics described this execution case or example. In this specification, the schematic expression of the above terms does not have to be directed to the same execution case or example. Moreover, the specific features, structures, materials or characteristics described may be combined in an appropriate manner in any one or more execution cases or examples. In addition, without contradiction, the technicians of this field can combine and assemble different execution cases or examples described in this specification and features of different execution cases or examples.

In addition, the terms “first” and “second” are used to describe purposes only and cannot be understood as indicating or implying relative importance or implying the number of indicated technical features. Thus, the features defined as “first” or “second” may include minimum one such feature, either explicitly or implicitly. In the description of this invention, “multiple” means minimum two, such as two, three, etc., unless otherwise specifically defined.

Any process or method in the flowchart or described in other ways herein can be understood as representing a module, fragment or part of code including one or more executable instructions for implementing the steps of a custom logic function or process, and the scope of the selected execution cases of this invention includes additional implementation, which may follow the sequence of showing or discussion. The functions can be executed in basic synchronous way or by inverse sequence, which shall be understood by the technicians of the field for the execution cases of this invention

The logics and/or steps represented in a flowchart or otherwise described herein, for example, the priority list of the executable instructions considered for realizing the logic functions can be realized in any computer-readable medium to serve the instruction execution systems, units or devices (e.g. systems based on computer, systems with processor or other systems which can take instructions for instruction execution systems, units or devices and execute these instructions), or work in combination with these instruction execution systems, units or devices. In terms of of this specification, “computer-readable medium” may be any unit that may contain, store, communicate, propagate or transmit programs for use by or in combination with instruction execution systems, units or devices. A more specific example (non-exhaustive list) of a computer-readable medium includes: electrical connection section (electronic unit) with one or more cables, portable computer disk case (magnetic unit), RAM, ROM, EPROM/FM, optical fiber unit, and CD-ROM. In addition, the computer-readable medium may even be the paper or other suitable medium on which a program can be printed. The program can be obtained through optical scanning, editing, decoding or even by electronic processing for the paper or other mediums and stored in the computer memory.

It is understood that all parts of this invention can be implemented by hardware, software, firmware, or a combination of them. In the above execution modes, a plurality of steps or methods may be realized by the software or firmware stored in memory and executed by a suitable instruction execution system. For example, if realized by hardware as the another execution mode, any one of the following technologies disclosed in this field or their combination can be executed: discrete logic circuit with logic gate circuit for realizing logic function of data signal, special integrated circuit with suitable combination logic gate circuit, programmable gate array (PGA) and field programmable gate array (FPGA).

The common technicians of this field can understand that all or part of the steps realizing the methods in the above execution cases can be completed by the hardware under the instructions of a program. The program can be stored in a computer-readable storage medium. When the program is executed, one or all steps of the method in execution cases can be included.

In addition, all functional units in each execution case of this invention can be integrated into one processing module or be physically independent, or integrated into one module each two or more. The integration in the module can be realized by hardware or by functional module of software. If the post-integration module is realized by the functional module of software and sold or used as an independent product, it can be stored in a computer-readable storage medium.

The storage medium mentioned above can be ROM, disk or CD. Although the execution cases of this invention have been shown and described above, it can be understood that the above execution cases are exemplary and cannot be understood as the restrictions of this invention. The common technicians of this field can change, modify, replace and transform the execution cases above within the scope of this invention.

The above mentioned is only a preferred specific execution mode of this invention instead of the whole protection scope of this invention. Any change or substitution that a technician familiar with this technical field can get easily from the technical scope disclosed by this invention shall be covered by the protection scope of this invention. Therefore, the protection scope of this invention shall be subject to the protection scope of the claims.

We claim:

1. A floor determination method for terminal devices based on the data of mass mobile Internet sensor, featured and including the steps:
S1: generate the atmospheric pressure data of the datum floor;
S2: divide the coordinate system of a map and establish city-level grid atmospheric pressure database;
S3: add commercial label to the grid data;
S4: add the datum atmospheric pressure and floor-height atmospheric pressure difference to each grid;
S5: judge the floor according to the device atmospheric pressure.

2. The floor determination method for terminal devices according to claim 1, featured that,
The S1 includes:
S11: select values: select three keywords that can exclusively identify the base station from the data of datum floor delivered from the terminal devices to determine an area;
S12: eliminate the invalid data: calculate the mid-value and take the difference between the post-elimination data value and the mid-value;
S13: calculate the filter threshold;
S14: determine the level atmospheric pressure value of the area where the terminal device is.

3. The floor determination method for terminal devices according to claim 2, featured that,
the keywords include: operator, quarter ID, base station ID, atmospheric pressure, time stamp.

4. The floor determination method for terminal devices according to claim 2, featured that,
the filtering threshold is 3%.

5. The floor determination method for terminal devices according to claim 1, featured that,
The S2 includes:
S21: determine the lower left and upper right range boundaries of a city on the selection map;
S22: take the grid at the lower left corner as the initial point, and use Python open source coordinate transformation base to turn the initial point 45 degrees anticlockwise to form the upper right coordinate of the grid;
S23: take the ending longitude as the next starting longitude, and keep the latitude unchanged;
S24: add the ID to the grid whenever a grid is generated;
S25: use the boundary database of a city and the ray algorithm to eliminate the grids outside the area of the city and generate the final grid base.

6. The floor determination method for terminal devices according to claim 1, featured that,
the S3 includes:
S31: add the commercial attribute mark to each grid combined with the data of points of interest (POI);
S32: match the commercial attribute of the POI corresponding to each grid using the GEO-HASH technology;
S33: after matching, add mark to each grid data.

7. The floor determination method for terminal devices according to claim 6, featured that,
the S4 includes:
S41: screen MapReduce using coordinates, and transform all base station data and related pressure data inside each grid to the datum atmospheric pressure and altitude therein by the datum atmospheric pressure generation method;
S42: determine the floor height according to the grid data with commercial marks;
S43: calculate the altitude and atmospheric pressure of each floor by taking the datum atmospheric pressure and altitude as the starting point and take them into the base. Each grid corresponds to the atmospheric pressure values of a plurality of floors.

8. The floor determination method for terminal devices according to claim 7, featured that,
the S5 includes:
S51: determine the longitude and latitude according to the base station ID delivered by the current device;
S52: determine the grid through the longitude and latitude according to the GEO-HASH algorithm;
S53: obtain the standard atmospheric pressures of a plurality of floors inside a grid according to the grid ID;
S54: search the range of the floor atmospheric pressure of the grid according to the atmospheric pressure of the current device, and add the mark to the current floor according to the search results.

9. (canceled)

10. (canceled)
